(19) United States
(12) Patent Application Publication
(10) Pub. No.: US 2016/0098938 A1
(43) Pub. Date: Apr. 7, 2016

(54) METHOD, SERVER, AND SYSTEM FOR PROVIDING LEARNING SERVICE

(71) Applicants: Won Kyu CHOI, Jeju-do (KR); NXC CORPORATION, Jeju-do (KR)

(72) Inventor: Won Kyu CHOI, Jeju-si (KR)

(73) Assignees: NXC CORPORATION, Jeju-si (KR); Won Kyu CHOI, Jeju-si (KR)

(21) Appl. No.: 14/892,570

(22) PCT Filed: Jul. 16, 2014
(86) PCT No.: PCT/KR2014/006437

§ 371 Date: Nov. 19, 2015

(30) Foreign Application Priority Data
Aug. 9, 2013 (KR) 10-2013-0095011
Dec. 13, 2013 (KR) 10-2013-0155096

(51) Int. Cl. G09B 7/00; G09B 5/00

(52) U.S. Cl. CPC G09B 7/00; G09B 5/00

(57) ABSTRACT

A method, a server, and a system for providing a learning service are provided. A learning service method may include the steps, which are executed by a server, of: receiving a first question from a first terminal; transmitting the first question to a second terminal; and receiving a first solution from the second terminal. The learning service method can provide a way to solve the problem through a direct mutual cooperation between users.

### TECHNICAL FIELD

The present invention relates to a method, server, and system for providing a learning service.

### BACKGROUND ART

In general, a digital learning system may be provided to a user to personally study through a system. The digital learning system may be served through a server configured to provide a learning system and a terminal configured to communicate with the server. The digital learning system may be provided through a program or application installed in the terminal.

In terms of a social learning system or cooperation learning system through which a plurality of users simultaneously participate in a study, a learning focus may be on technology related to a question setting in lieu of an interaction between users. As an example, when a first user setting a question and a second user solving the question are simultaneously participate in the learning system, a focus of the learning system may be a method in which the first user generates a question to be solved by the second user, or a method providing a solution of the second user with respect to the generated question as a response.

Korea Patent Laid-open Publication No. 10-2011-0115828 (published on Oct. 24, 2011) discloses an invention related to a terminal providing a question solving function to a user to solve a question without geographic or time restrictions, and a user interface method providing the question solving function by using a mobile terminal. The invention may include an inputter through which a user performs an input by using one of a touch panel and a keyboard, a controller to read a question study application corresponding to an input signal in response to a user request applied by the inputter such that the question study application is displayed, a display to display the question study application based on the user request, an intro application to display one of a question selection area in which the user attempts to solve a question and a continue area in which the user continues to solve the question on an initial screen of the question study application, a question set selection application through which the user selects and solves one of a plurality of question sets, a mode selection application to display a screen to be viewed by the user such that the user selects one of a mock test mode and a learning mode before solving the question set, a question set solving application to display a question selected by the user such that the user solves the question, and a memory to store a question study application including a score result application through which the question submitted by the user is scored.

### DISCLOSURE OF INVENTION

### Technical Goals

An aspect of the present invention provides a method, a server, and a system for providing a learning service.

Another aspect of the present invention provides a method, a server, and a system for providing a learning service in which functions of a questioner and an answerer are switched through game.

### Technical Solutions

According to an aspect of the present invention, there is provided a learning service method performed by a server, the method including receiving, from a first terminal, data indicating a first question set by a first user of the first terminal, transmitting the data indicating the first question to a second terminal, receiving data indicating a first solution selected by a second user of the second terminal from a plurality of solutions of the first question, from the second terminal, transmitting the data indicating the first solution to the first terminal, receiving data indicating a first review of the first user with respect to the first solution from the first terminal, transmitting the data indicating the first review to the second terminal, receiving data indicating a second solution selected by the second user from the plurality of solutions, from the second terminal, determining whether the second solution is an answer to the first question, and transmitting data indicating whether the second solution is the answer to the first question to the second terminal.

The first question may be a question about an English sentence corresponding to a suggested Korean sentence, and, among the plurality of solutions, a solution corresponding to the answer to the first question may include words indicating the English sentence and a solution differing from the answer to the first question includes words not indicating the English sentence.

The first question may be a question about an English sentence corresponding to a suggested Korean sentence, and the plurality of solutions may be solutions corresponding to a portion of the English sentence.

The data indicating the first review may be at least one of data indicating a selection of the first user performed on whether the first solution is the answer to the first question and data indicating a comment from the first user with respect to the first solution.

The learning service method may further include providing a reward to the second user of the second terminal when the second solution is the answer to the first question.

The learning service method may further include receiving, from the first terminal or the second terminal, data indicating a request for a history in which one of the first question, the first solution, the first review, and the second solution is recorded.

The learning service method may further include generating the history.

The learning service method may further include transmitting the data indicating the generated history to the first terminal or the second terminal from which the request for the history is received.

The learning service method may further include receiving data indicating a request from the first terminal to create a room.

The learning service method may further include creating a first room, the first room may be added to at least one room provided by the server and, in each of the at least one room, a question may be set and solved by a user of at least one terminal entering a corresponding room.

The learning service method may further include allowing the first terminal to enter the first room.

The learning service method may further include receiving data indicating a request for entering the first room from the second terminal.

The learning service method may further include allowing the second terminal to enter the first room.

The learning service method may further include inviting the second user as a solver of the first question.

The data indicating the request for creating the room may include data indicating the second terminal of which entry to the first room to be created is allowed by the first user of the first terminal.

The inviting may include transmitting data indicating an invitation to the created first room, to the second terminal to which entry is allowed.

The learning service method may further include receiving data indicating a request for removing the first room, from the first terminal or the second terminal.

The learning service method may further include removing the first room.

The learning service method may further include transmitting data on a recommended user list as a candidate user to be allowed entry to the first room, to the first terminal.

The recommended user list may include the second user of the second terminal.

The recommended user list may be a list representing at least one user having a level within a range determined based on a level of the first user of the first terminal.

The learning service method may further include generating data indicating an explanation about the first question.

The learning service method may further include transmitting data indicating the explanation of the first question to at least one of the first terminal and the second terminal.

The learning service method may further include transmitting data indicating that functions of the first terminal and the second terminal are switched to each other, to the first terminal and the second terminal.

The learning service method may further include receiving data on a second question set by the second user from the second terminal.

The learning service method may further include transmitting the data on the second question to the first terminal.

The learning service method may further include receiving data indicating a third solution selected by the first user from a plurality of solutions of the second question, from the first terminal.

The learning service method may further include transmitting the data indicating the third solution to the second terminal.

The learning service method may further include receiving data indicating a second review of the second user with respect to the third solution from the second terminal.

The learning service method may further include transmitting the data indicating the second review to the first terminal.

The learning service method may further include transmitting the data indicating the second review to the first terminal.

The learning service method may further include determining whether the fourth solution is an answer to the second question.

The learning service method may further include transmitting data indicating whether the fourth solution is the answer of the second question, to the first terminal.

The learning service method may further include selecting a plurality of questions based on at least one of a level of the first user and a level of the second user from questions provided in the server.

The learning service method may further include transmitting data indicating the plurality of questions to the first terminal.

The first question may be one of the plurality of questions.

According to another aspect of the present invention, there is also provided a learning service server including a communicator and a processor, wherein the communicator is configured to receive data indicating a first question set by a first user of a first terminal from the first terminal, transmit the data indicating the first question to a second terminal, receive data indicating a first solution selected by a second user of the second terminal from a plurality of solutions of the first question from the second terminal, transmit the data indicating the first solution, receive data indicating a first review of the first user with respect to the first solution from the first terminal, transmit the data indicating the first review to the second terminal, receive data indicating a second solution selected by the second user from the plurality of solutions from the second terminal, and transmit data indicating whether the second solution is an answer to the first question to the second terminal, and wherein the processor is configured to determine whether the second solution is the answer to the first question.

The process may be configured to provide a reward to the second user of the second terminal when the second solution is the answer to the first question.

The communicator may be configured to receive data indicating a request from the first terminal to create a room.

The processor may be configured to generate a first room to allow the first terminal entry to the first room, wherein the first room may be added to at least one room provided by the server, and in each of the at least one room, a question may be set and solved by a user of at least one terminal entering a corresponding room.

The communicator may be configured to receive data indicating a request from the second terminal for entry to the first room.

The processor may be configured to allow the second terminal entry to the first room.

The processor may be configured to generate data on a recommended user list corresponding to a candidate user allowed entry to enter the first room.

The communicator may be configured to transmit the data on the recommended user list to the first terminal.

The recommended user list may include the second user of the second terminal.

The processor may be configured to generate data indicating that functions of the first terminal and the second terminal are switched.

The communicator may be configured to transmit the data indicating that the functions of the first terminal and the second terminal are switched, to the first terminal and the second terminal, receive data on a second question set by the second user from the second terminal, transmit the data on the second question to the first terminal, receive data indicating a third solution selected by the first user from a plurality of solutions of the second question from the first terminal, transmit the data indicating the third solution to the second terminal, receive data indicating a second review of the second user with respect to the third solution from the second terminal, transmit the data indicating the second review of the second user with respect to the third solution from the second terminal, and receive data indicating a fourth solution selected by the first user from the plurality of solutions from the first terminal.

The processor may be configured to determine whether the fourth solution is an answer to the second question and generate data indicating whether the fourth solution is the answer to the second question.

The communicator may be configured to transmit the data indicating that whether the fourth solution is the answer to the second question to the first terminal.

The processor may be configured to select a plurality of questions from questions provided in the server based on at least one of a level of the first user and a level of the second user.

The communicator may be configured to transmit data indicating the plurality of questions to the first terminal.

The first question may be one of the plurality of questions.

According to still another aspect of the present invention, there is also provided a learning service method performed by a learning service system, the system including receiving, by a first terminal, data indicating a first solution of a first question from a server, receiving, by the first terminal, a first review for the first solution from a first user of the first terminal to generate data indicating the received first review, transmitting, by the first terminal, the data indicating the first review to the server, transmitting, by the server, the data indicating the first review a second terminal of a second user creating the first solution, receiving, by the second terminal, the data indicating the first review from the server, providing, by the second terminal, the first review to the second user, receiving, by the second terminal, a second solution selected by the second user to generate data indicating the second solution, and transmitting, by the second terminal, the data indicating the second solution to the server.

According to still another aspect of the present invention, there is also provided a learning service method performed by a server, the method including receiving data indicating a first question set by a first user of a first terminal from the first terminal, transmitting the data indicating the first question to a second terminal, receiving data indicating a first solution selected by a second user of the second terminal from a plurality of solutions of the first question from the second terminal, determining whether the first solution is an answer to the first question, and transmitting data indicating whether the first solution is the answer to the first question to the second terminal.

The learning service method may further include receiving data indicating a request for a history in which at least one of the first question and the second question is recorded is requested, from the first terminal or the second terminal.

The learning service method may further include generating the history.

The learning service method may further include transmitting the data indicating the request for the history to the first terminal or the second terminal requesting the history.

According to yet another aspect of the present invention, there is also provided a learning service server including a communicator and a processor, wherein the communicator is configured to receive data indicating a first question set by a first user of a first terminal from the first terminal, transmit the data indicating the first question to a second terminal, receive data indicating a first solution selected by a second user of the second terminal from a plurality of solutions of the first question from the second terminal, and transmit data indicating whether the first solution is an answer to the first question to the second terminal, and wherein the processor is configured to determine whether the first solution is the answer to the first question.

According to further another aspect of the present invention, there is also provided a learning service method performed by a server, the method including searching a plurality of questions for a first question based on a learning level of a user of a terminal, transmitting data indicating the first question to the terminal, receiving data indicating a solution selected by the user of the terminal from a plurality of solutions of the first question from the terminal, determining whether the solution is an answer to the first question, and transmitting data indicating whether the solution is the answer to the first question to the terminal.

The learning service method may further include receiving a second question generated by the user of the terminal and an answer to the second question from the terminal.

The learning service method may further include incorporating the second question to the plurality of questions.

A difficulty level of the second question may be set by the user.

The learning service method may further include transmitting a request for setting a second question for another user to the terminal.

The learning service method may further include receiving a request for setting the first question from the terminal.

The plurality of questions may be set by a user of the server.

According to still another aspect of the present invention, there is also provided a learning service server including a processor configured to search a plurality of questions for a first question based on a learning level of a user of a terminal, and a communicator configured to transmit data indicating the first question to the terminal and receive data indicating a solution selected by the user of the terminal from a plurality of solutions of the first question from the terminal, wherein the processor is configured to determine whether the solution is an answer to the first question, and wherein the communicator is configured to transmit, to the terminal, data indicating whether the solution is the answer to the first question.

### Advantageous Effects

In one aspect, there is provided a method, a server, and a system for providing learning service.

In another aspect, there is also provided a method, a server, and a system for providing a learning service in which functions of a questioner and an answerer are switched through a game.

In still another aspect, it is possible to learn English while two users are naturally switching functions of the users through a game.

### BRIEF DESCRIPTION OF DRAWINGS

FIG. 1 is a diagram illustrating a configuration of a learning service server according to an example embodiment.

FIG. 2 is a diagram illustrating a configuration of a learning service system according to an example embodiment.

FIG. 3 is a flowchart illustrating a learning service method according to an example embodiment.

FIG. 4 is a signal flowchart illustrating a room creation method according to an example embodiment.

FIG. 5 is a signal flowchart illustrating a method of solving a first question according to an example embodiment.

FIG. 6 is a signal flowchart illustrating a method of providing an explanation according to an example embodiment.

FIG. 7 is a signal flowchart illustrating a method of providing a history according to an example embodiment.

FIG. 8 is a signal flowchart illustrating a method of solving a second question and switching functions according to an example embodiment.

FIG. 9 is a signal flowchart illustrating a room removal method according to an example embodiment.

FIG. 10 illustrates a method of selecting an English sentence corresponding to a suggested Korean sentence according to an example embodiment.

FIG. 11 illustrates a method of reviewing a solution and requesting an explanation about a question according to an example embodiment.

FIG. 12 illustrates a method of reviewing a solution and indicating a requested history.

FIG. 13 illustrates a method of providing a reward according to an example embodiment.

FIG. 14 is a signal flowchart illustrating a method of providing a question to a terminal according to an example embodiment.

### BEST MODE FOR CARRYING OUT THE INVENTION

Hereinafter, example embodiments will be described in detail with reference to the accompanying drawings, wherein like reference numerals refer to the like elements throughout.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

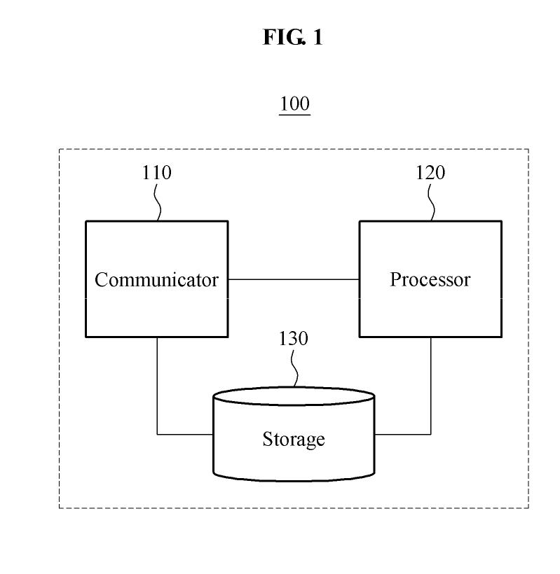

FIG. 1 is a diagram illustrating a learning service server according to an example embodiment.

A learning service server 100 may include a communicator 110, a processor 120, and a storage 130. Hereinafter, the learning service server may also be referred to as, for example, a server 100.

The communicator 110 may transmit data to a terminal and receive the data from the terminal.

When the communicator 110 transmits the data, the communicator 110 may perform data transmission based on a wired communication method or a wireless communication method. The wireless communication method may include a communication method performed between a mobile terminal and a communication base station, and a wireless fidelity (Wi-Fi). The communication method performed between the mobile terminal and the communication base station may include, for example, a cellular method, a third generation (3G) method, and a fourth generation (4G) method. To perform the communication, the communicator 110 may maintain a connection with the terminal.

The processor 120 may include a processor. Alternatively, the processor 120 may indicate at least one processor.

The processor 120 may process the data received by the communicator 110. The processor 120 may generate data to be transmitted to the terminal through the communicator 110.

The storage 130 may store data or information received by the communicator 110. Also, the storage 130 may store data or information processed by the processor 120.

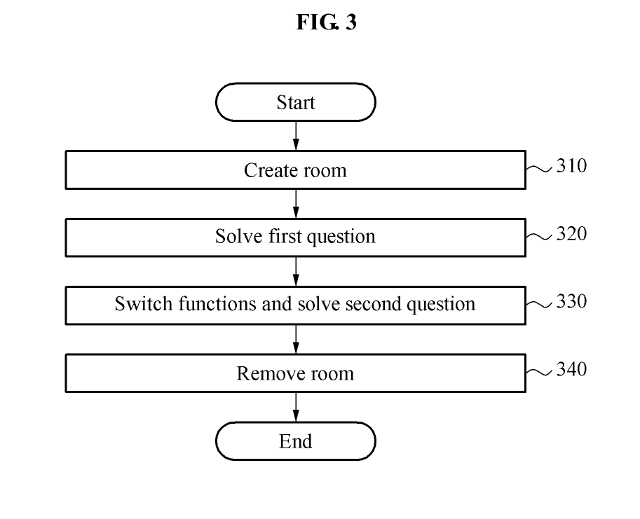

Description related to the communicator 110, the processor 120, and the storage 130 will be also provided with reference to FIGS. 3 through 14.

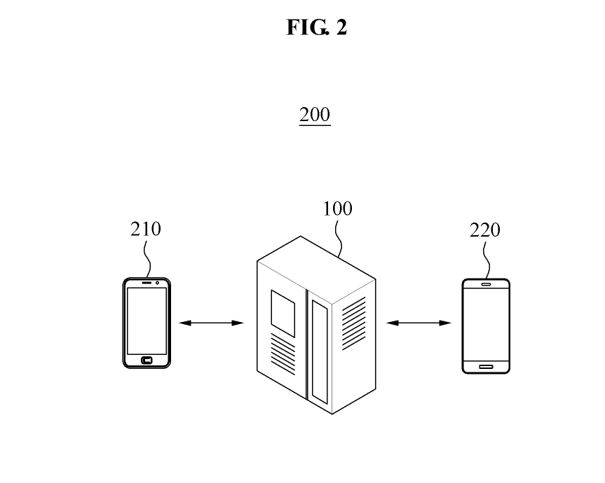

FIG. 2 is a diagram illustrating a learning service system according to an example embodiment.

A learning service system 200 may include the server 100 and a plurality of terminals. Hereinafter, the learning service system 200 may also be referred to as, for example, a system 200. The plurality of terminals may include a first terminal 210 and a second terminal 220.

Each of the first terminal 210 and the second terminal 220 may be, for example, a game console, a smartphone, a personal computer (PC), and a tablet PC.

In an example embodiment, the first terminal 210 and the second terminal 220 may access the server through applications installed in the first terminal 210 and the second terminal 220, respectively.

The server 100 may communicate with the first terminal 210 and the second terminal 220 through the communicator 110.

The system 200 may provide a learning service in which learners cooperate with one another to learn.

Learning may indicate, for example, learning about English. As an example, during the learning, a questioner suggests a Korean phrase including, for example, a sentence, a word, and an idiom, and an answerer gives an English phrase corresponding to the suggested Korean phrase as a response. In this example, contents of the response may be an English phrase having the same meaning as the Korean phrase partially or as a whole.

In an example, a first user of the first terminal 210 may select a second user of the second terminal 220 and create a room. In the room, the first user and the second user may proceed with the learning by turns.

In an example, each of the first user of the first terminal 210 and the second user of the second terminal 220 may access the server 100 to perform a learning activity provided in the system 200 any time.

The processor 120 of the server 100 may store the learning activity performed by the first user or the second user. The processor 120 may generate a learning event for each learning activity such that the first user and the second user have a learning interaction with each other. Here, the learning event may include at least one of a question setting, providing a solution of the set question, and reviewing the solution.

The system 200 may provide a learning service to the first user and the second user by causing a direct interaction between the first user and the second user. For example, when the system 200 applies a peer teaching system, the first user and the second user may send and receive a message to and from one another. During the foregoing process, a cooperative learning may be performed.

The aforementioned learning process, learning activity, and interaction may be realized though a game provided in the system 200. A user may be interested in the game and spontaneously perform the learning activity.

Also, the user may perform the learning activity by manipulating an avatar or a character in the game. Thus, learning activities and interactions of users may be expressed by characters or avatars of the users in the game.

The system 200 may contribute to development of a digital learning system, an increase in industrial usability of a learning service, and a technical advance of the learning service.

Since the descriptions provided with reference to FIG. 1 are also applicable here, repeated descriptions will be omitted for increased clarity and conciseness.

FIG. 3 is a flowchart illustrating a learning service method according to an example embodiment.

A learning service method provided in the system 200 may include operation 310 in which a room is created, operation 320 in which a first question is solved, operation 330 in which functions are switched and a second question is solved, and operation 340 in which the room is removed.

The room may be a configuration for specifying users to perform the same game among all users. The server 100 may provide at least one room to all users.

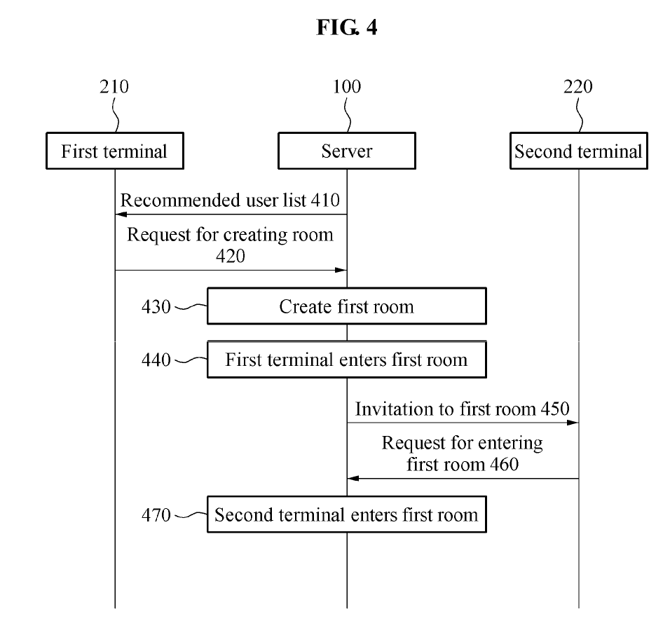

Descriptions related to operation 310 in which the room is created will be provided with reference to FIG. 4.

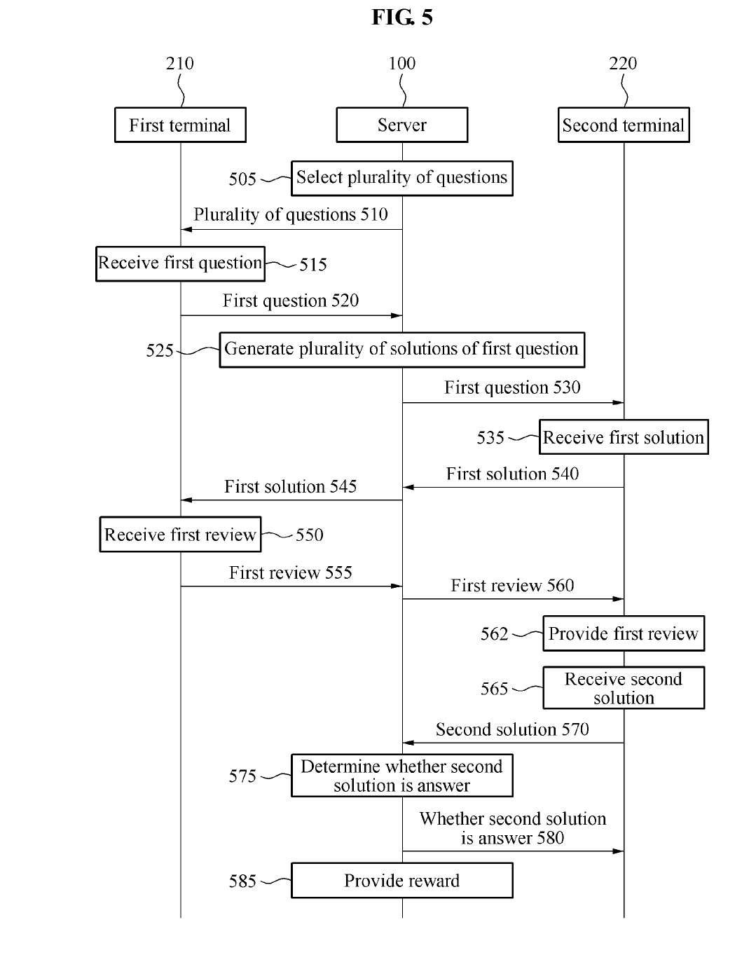

Descriptions related to operation 320 in which a first question is solved will be provided with reference to FIGS. 5 through 7.

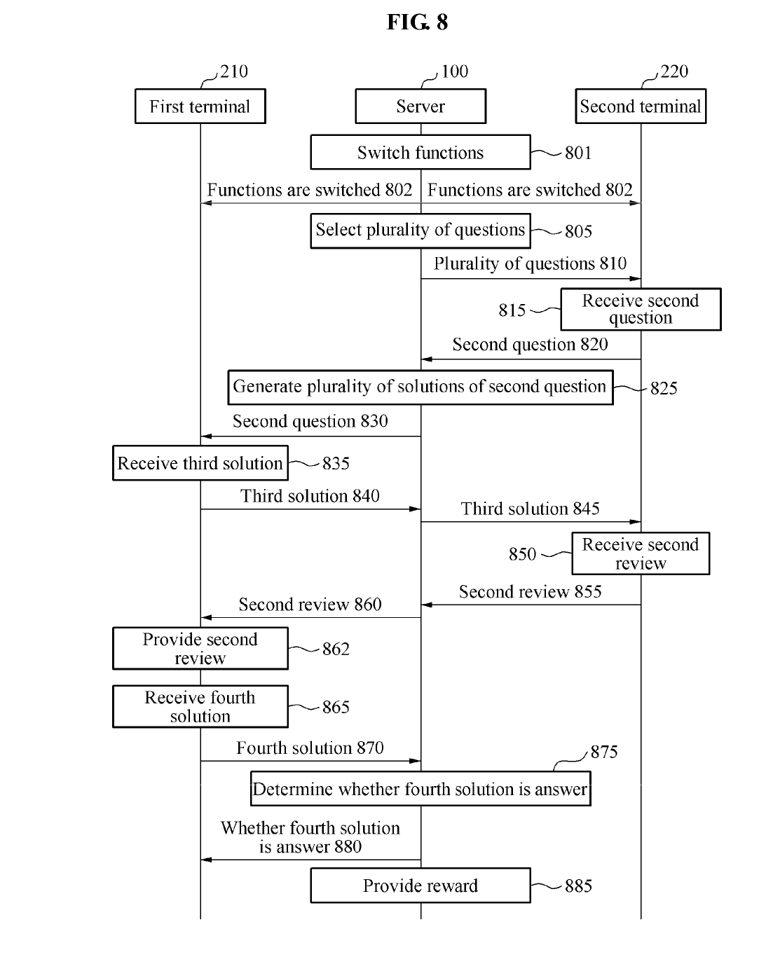

Descriptions related to operation 330 in which functions are switched and a second question is solved will be provided with reference to FIG. 8.

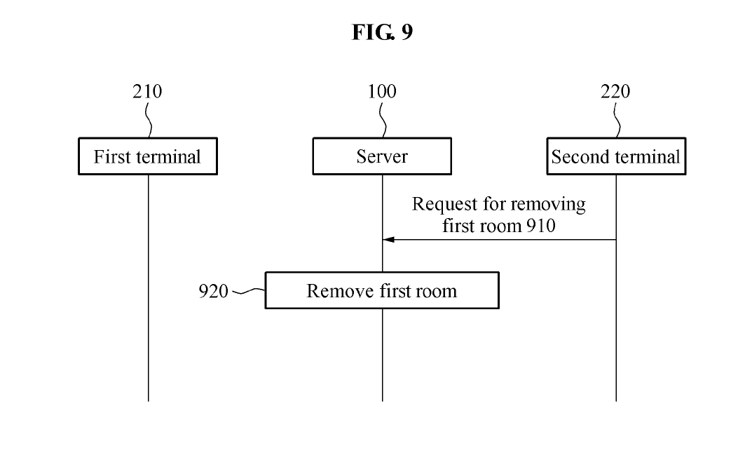

Descriptions related to operation 340 in which the room is removed will be also provided with reference to FIG. 9.

Since the descriptions provided with reference to FIGS. 1 and 2 are also applicable here, repeated descriptions will be omitted for increased clarity and conciseness.

FIG. 4 is a signal flowchart illustrating a room creation method according to an example embodiment.

Operation 310 described with reference to FIG. 3 may include operations 410 through 470.

In operation 410, the server 100 may transmit data on a recommended user list including candidate users to enter a created room, to the first terminal 210.

The processor 120 of the server 100 may generate the data on the recommended user list. The communicator 110 of the server 100 may transmit the generated data on the recommended user list to the first terminal 210.

The recommended user list may be generated based on a level of a user. For example, the recommended user list may be a list including at least one user having a level within a predetermined range determined based on a level of a first user of the first terminal 210.

Here, the level may be a value indicating an achievement of a user in a learning service. For example a user of a level 2 may have a higher achievement than that of a user of a level 1. The processor 120 may determine the level of the user based on at least one of a probability that a solution of the user is an answer of a suggested question, the number of questions solved by the user, a difficulty level of the question, and a user response time from a time at which the question is set.

The level within the predetermined level may be, for example, a level within a predetermined range of the level of the first user, a level higher than the predetermined range of the level of the first user, and a level lower than the predetermined range of the level of the first user.

In operation 420, the first terminal 210 may transmit data indicating a request for creating a room for the learning service to the communicator 110 of the server 100.

In a process of making the request for creating the room, the first terminal 210 may determine a second user of the second terminal 220 to be a user of which an entry to the created room is allowed. The second user of the second terminal 220 may be a user stored in the first terminal 210 determined by the first user. Also, the second terminal 220 may be a user included in a recommended user list provided by the server 100.

The first terminal 210 may generate the data indicating the request for creating the room.

The data indicating the request for creating the room may include data indicating the second terminal 220 of which an entry to the created room is allowed by the first user of the first terminal 210.

In operation 420, the communicator 110 of the server 100 may receive the data indicating the request for creating the room from the first terminal 210.

In operation 430, the processor 120 of the server 100 may generate the room for the learning service based on the received data.

Here, the generated room may be added to at least one room provided by the server 100. In the at least one room, a user of at least one terminal entering each room may set and solve a question.

In operation 440, the processor 120 of the server 100 may allow the first terminal 210 to enter the created room.

In operation 450, the server 100 may invite the second user of the second terminal 220 to the room as a solver of a question.

The processor 120 of the server 100 may generate data indicating an invitation to the room.

The communicator 110 of the server 100 may transmit the data indicating the invitation to the second terminal 220. The second terminal 220 of which the entry to the created room is to be allowed may be a terminal designated by the first user of the first terminal and included in the data received by the communicator 110 of the server 100 from the first terminal 210 in operation 420.

Also, after performing of operation 440, the communicator 110 of the server 100 may receive data indicating the second terminal 220 of which the entry to the room is to be allowed, from the first terminal 210.

In operation 460, the second user of the second terminal 220 may make a request for entering the room through a room searching or the invitation of operation 450. The second terminal 220 may generate data indicating the request for entering the room. The second terminal 220 may transmit the data indicating the request for entering the room to the communicator 110 of the server 100.

The communicator 110 of the server 110 may receive the data indicating the request for entering the room, from the second terminal 220.

In operation 470, the processor 120 of the server 100 may allow the second terminal 220 to enter the room.

Since the descriptions provided with reference to FIGS. 1 through 3 are also applicable here, repeated descriptions will be omitted for increased clarity and conciseness.

FIG. 5 is a signal flowchart illustrating a method of solving a first question according to an example embodiment.

Operation 320 in which a first question is solved as described with reference to FIG. 3 may include operations 505 through 585.

As described with reference to FIG. 4, when the first terminal 210 and the second terminal 220 enter a room, a learning service may be provided in the room.

In operation 505, the processor 120 of the server 100 may select a plurality of questions.

The processor 120 may select the plurality of questions among questions provided in the server 100, based on at least one of a level of a first user and a level of a second user. As an example, the processor 120 may select a plurality of questions corresponding to the level of the second user. As another example, the processor 120 may select a plurality of questions corresponding to a higher level than the level of the second user. As still another example, the processor 120 may select a plurality of questions corresponding to a lower level than the level of the first user.

The number of selected questions may be, for example, three.

In operation 510, the server 100 may transmit the selected questions to the first terminal 210.

The processor 120 of the server 100 may generate data indicating the selected questions.

The communicator 110 of the server 110 may transmit the data indicating the selected questions to the first terminal 210.

The first terminal 210 may receive the data indicating the selected questions.

In operation 515, a first user of the first terminal 210 may set a first question. The first terminal 210 may receive the set question from the first user.

The first terminal 210 may generate data indicating the first question.

The first question may be a question directly set by the first user. Also, the first question may be one of the plurality of questions received by the first terminal 210 in operation 510.

The first question may be a question on a corresponding English sentence to be provided in response to a Korean sentence suggested by the first user or the server 100.

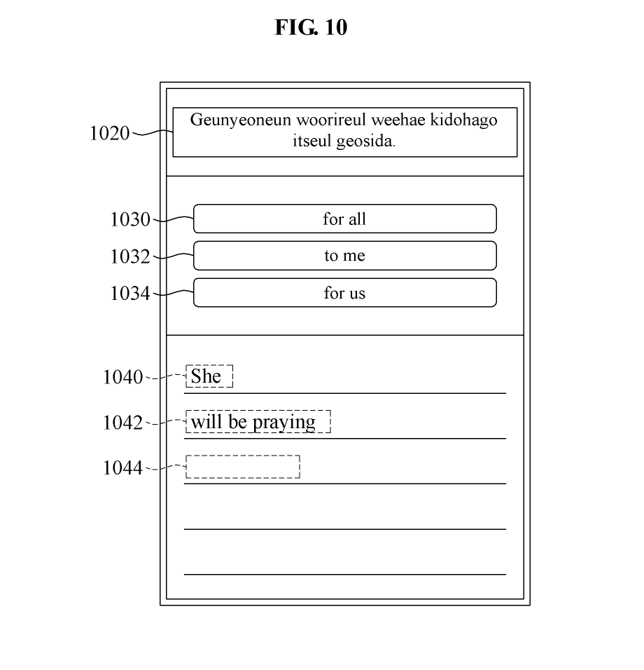

Descriptions related to the first question will also be provided with reference to FIG. 10.

In operation 520, the first terminal 210 may transmit the data indicating the first question to the communicator 110 of the server 100. From the first terminal 210, the communicator 110 of the server 110 may receive the data indicating the first question set by the first user of the first terminal 210.

In operation 525, the server 100 may generate a plurality of solutions of the first question.

In response to the received first question, the processor 120 of the server 100 may generate the plurality of solutions of the first question. Among the plurality of solutions, a solution corresponding to an answer of the first question may include words of the English sentence corresponding to the suggested Korean sentence. Also, a solution not corresponding to the answer to the first question may include words irrelevant to the English sentence corresponding to the suggested Korean sentence.

The plurality of solutions may include words configuring the English sentence corresponding to the answer to the question partially or as a whole, and words configuring the English sentence neither partially nor as a whole despite a similarity in meaning or form to the words of the English sentence. For example, among the plurality of solutions, only one solution may correspond to the answer.

The plurality of solutions may be solutions corresponding to a portion of the English sentence.

As an example, when words partially or fully configuring the English sentence corresponding to the answer to the first question are “for me”, words configuring the English sentence corresponding to the answer to the first question neither partially nor as a whole despite a similarity in meaning or form to “for me” may be, for example, “for all”, “for us” and “to me”.

In operation 530, the server 100 may transmit the data indicating the first question to the second terminal 220.

The processor 120 of the server 100 may generate the data indicating the first question. The data indicating the first question may include data indicating the plurality of solutions generated in operation 525.

The communicator 110 of the server 110 may transmit the data indicating the first question to the second terminal 220.

The second terminal 220 may receive the data indicating the first question from the communicator 110 of the server 100.

In operation 535, the second user of the second terminal 220 may generate a first solution of the first question. The second terminal 220 may receive the first solution of the first question from the second user.

The first solution may be a solution selected by the second user of the second terminal 220 from the plurality of solutions of the first question.

In operation 540, the second terminal 220 may transmit data indicating the first solution of the first question to the communicator 110 of the server 100.

The second terminal 220 may generate the data indicating the first solution.

The communicator 110 of the server 110 may receive, from the second terminal 220, data indicating the first solution selected by the second user of the second terminal 220 from the plurality of solutions of the first question.

In operation 545, the server 100 may transmit the data indicating the first solution to the first terminal 210.

The processor 120 of the server 100 may generate the data indicating the first solution based on the first solution generated in operation 535.

The communicator 110 of the server 110 may transmit the data indicating the first solution to the first terminal 210.

The first terminal 210 may receive the data indicating the first solution of the first question from the communicator 110 of the server 100.

In operation 550, the first terminal 210 may receive a first review on the first solution from the first user.

The first terminal 210 may generate data indicating the received first review.

The first review may be, for example, a response, an assessment, and a selection provided by the first user determining whether the first solution is the answer to the first question. Also, the first review may be a comment of the first user about the first solution.

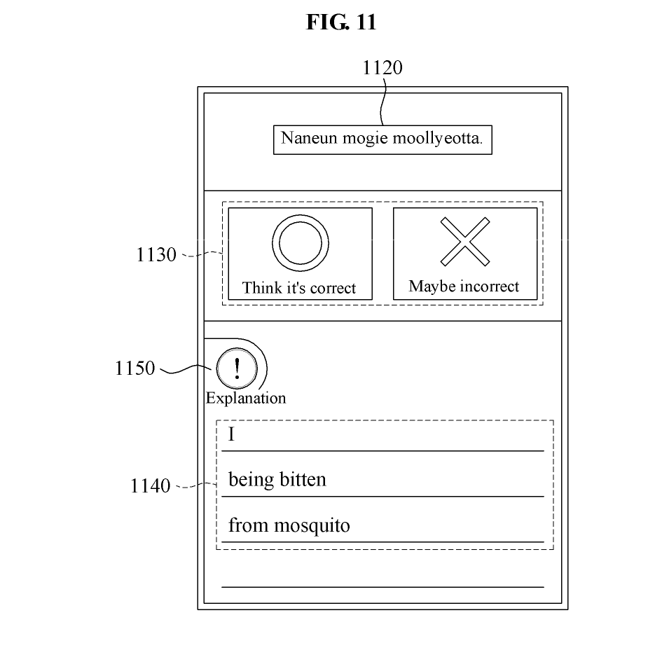

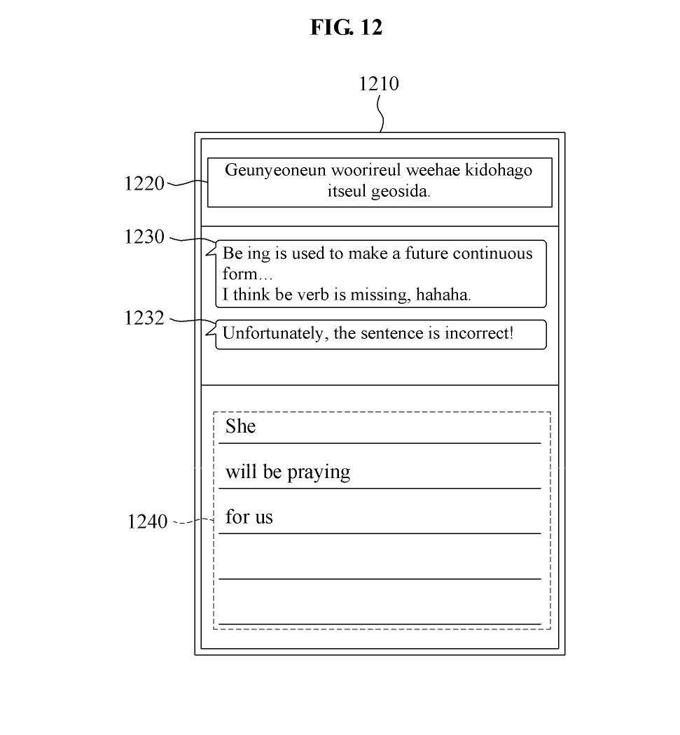

Descriptions related to the first review will also be provided with reference to FIGS. 11 and 12.

The data indicating the first review may be at least one of 1) data indicating a selection of the first user determining whether the first solution is the answer to the first question and 2) data indicating a comment of the first user about the first solution. For example, the first review may indicate whether the first solution is the answer to the first question and/or the comment about the first solution.

In operation 555, the first terminal 210 may transmit the data indicating the generated first review to the communicator 110 of the server 100.

The communicator 110 may receive data indicating the first review of the first user on the first question, from the first terminal 210.

In operation 560, the server 100 may transmit the received data indicating the first review to the second terminal 220 of the second user creating the first solution.

The processor 120 of the server 100 may generate the data indicating the first review based on the first review received in operation 555.

The communicator 110 of the server 100 may transmit the data indicating the first review to the second terminal 220.

The second terminal 220 may receive the data indicating the first review from the communicator 110 of the server 100.

In operation 562, the second terminal 220 may provide the data indicating the first review to the second user.

Based on the first review, the second terminal 220 may provide, to the second user, at least one of a result that the first user determines whether the first solution is the answer to the first question, and the comment of the first user about the first solution.

Through this, the second user may verify whether the first solution created or selected by the second user is the answer to the first question.

In operation 565, the second terminal 220 may receive a second solution selected by the second user. The second terminal 220 may generate data indicating the received second solution.

The second solution may be a solution selected by the second user from the plurality of solutions. Here, the plurality of solutions may be the same as the plurality of solutions suggested when the first solution is selected. For example, the second solution may be a second solution selected by the second user from the plurality of solutions. The second user may select the second solution in consideration of the first review on the first solution. The second user may generate or select the second solution by changing the first solution. Concisely, the second solution may be generated based on the first solution. Also, the second solution may be the same as the first solution.

In operation 570, the second terminal 220 may transmit the data indicating the second solution to the communicator 110 of the server 100.

The communicator 110 may receive, from the second terminal 220, the data indicating the second solution selected by the second user from the plurality of solutions.

The foregoing operations 545 through 570 may not be performed depending on an example. For example, operation 575 may be performed after operation 540.

In operation 575, the processor 120 of the server 100 may determine whether the second solution is the answer to the first question.

Also, when operations 545 through 570 are not performed, the processor 120 may determine whether the first solution is the answer to the first question. In operation 580, the server 100 may transmit the data indicating whether the second solution is the answer to the first question, to the second terminal 220.

The processor 120 of the server 100 may generate the data indicating whether the second solution is the answer to the first question.

The communicator 110 of the server 110 may transmit the generated data indicating whether the second solution is the answer to the first question, to the second terminal 220.

Also, when operations 545 through 570 are not performed, the processor 120 may generate the data indicating whether the first solution is the answer to the first question. The communicator 110 may transmit the generated data indicating whether the first solution is the answer to the first question, to the second terminal 220.

In operation 585, when the second solution is the answer to the first question, the processor 120 may provide a reward to the second user of the second terminal 220.

Also, when operations 545 through 570 are not performed, and when the first solution is the answer to the first question, the processor 120 may provide a reward to the second user of the second terminal 220.

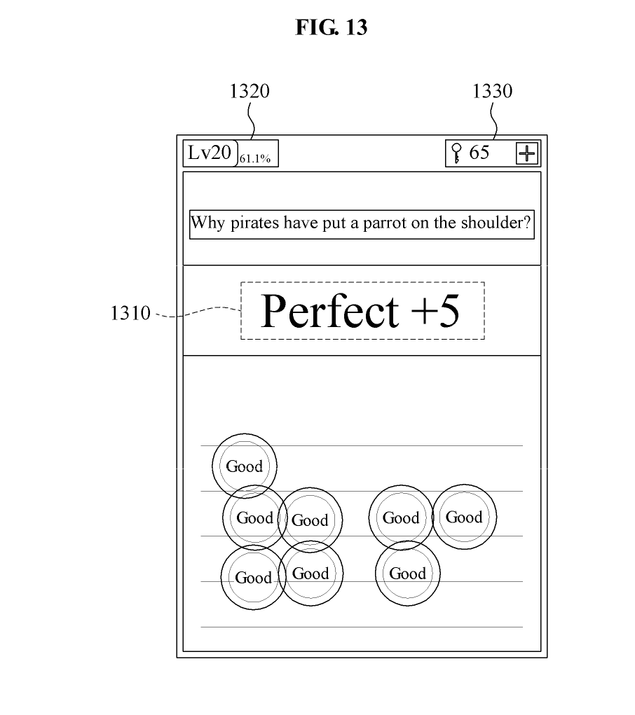

Descriptions related to the provided reward will also be provided with reference to FIG. 13.

Since the descriptions provided with reference to FIGS. 1 through 4 are also applicable here, repeated descriptions will be omitted for increased clarity and conciseness.

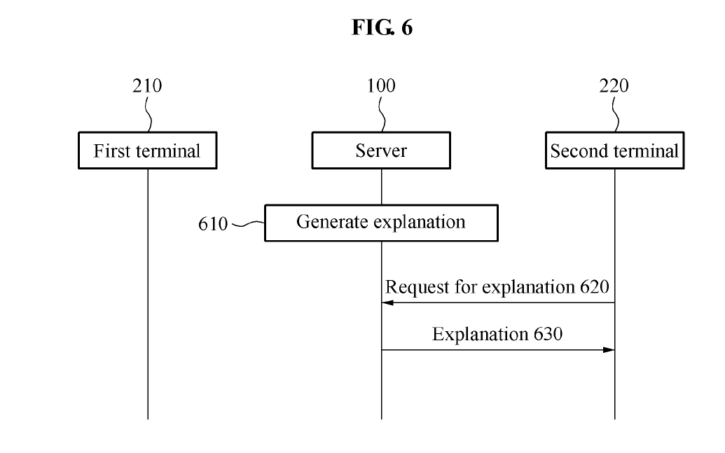

FIG. 6 is a signal flowchart illustrating a method of providing an explanation according to an example embodiment.

Operation 320 in which a first question is solved as described with reference to FIG. 3 may include operations 610 through 630.

In operation 610, the processor 120 may generate an explanation about a first question. The processor 120 may generate data indicating the generated explanation.

In operation 620, the communicator 110 may receive data indicating a request for the explanation about the first question, from the first terminal 210 or the second terminal 220.

An order of operations 610 and 620 may be changed. For example, operation 610 may be performed after operation 620.

In operation 630, the communicator 110 may transmit the data indicating the explanation about the first question, to the first terminal 210 or the second terminal 220 requesting the explanation.

Operations 610 through 630 may be performed after operation 570 described with reference to FIG. 5.

When operations 610 through 630 are performed after operation 570, operation 630 may also be performed while operation 620 is not performed.

In operation 630, the communicator 110 may transmit the data indicating the explanation about the first question to at least one of the first terminal 210 and the second terminal 220.

Since the descriptions provided with reference to FIGS. 1 through 5 are also applicable here, repeated descriptions will be omitted for increased clarity and conciseness.

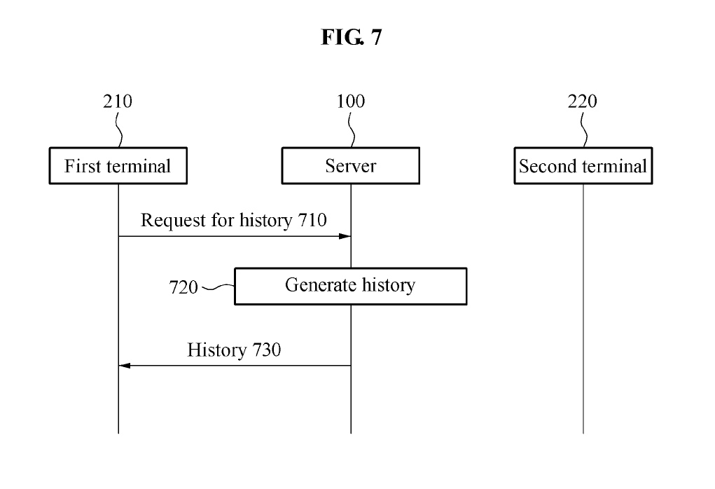

FIG. 7 is a signal flowchart illustrating a method of providing a history according to an example embodiment.

Operation 320 in which a first question is solved as described with reference to FIG. 3 may include operations 710 through 730.

In operation 710, the communicator 110 may receive, from the first terminal 210 or the second terminal 220, data indicating a request for a history in which at least one of the first question, a first solution, a first review, and a second solution.

In operation 720, the processor 120 may generate the history or extract the history from data stored in the server 100 in response to the request. The processor 120 may generate data indicating the generated history.

To provide the history, the processor 120 may store data indicating the first question, data indicating the first solution, data indicating the first review, and data indicating the second solution after generating of each data, after receiving of each data, or before transmitting of each data.

An order of operations 710 and 720 may be changed. For example, operation 720 may be performed prior to operation 710.

In operation 730, the communicator 110 may transmit the data indicating the history, to the first terminal 210 or the second terminal 220 requested the history.

Operations 710 through 730 may be performed in a process of performing operations 530 through 585 described with reference to FIG. 5. For example, operations 710 through 730 may be performed after operation 530 is performed and before operation 535 is performed.

Descriptions related to the history will also be provided with reference to FIG. 12.

Since the descriptions provided with reference to FIGS. 1 through 6 are also applicable here, repeated descriptions will be omitted for increased clarity and conciseness.

FIG. 8 is a signal flowchart illustrating a method of solving a second question and switching functions according to an example embodiment.

Operation 330 in which functions are switched and a second question is solved as described with reference to FIG. 3 may include operations 801 through 885.

Operations 801 through 885 of FIG. 8 may be performed after operation 585 of FIG. 8.

In operation 801, the processor 120 may switch functions of the first terminal 210 and the second terminal 220. For example, as a result of the switching, a function of the first terminal 210 may be switched from a questioner to a solver. By switching the functions, a function of the second terminal 220 may be switched from a solver to a questioner.

The processor 120 may generate data indicating that the functions are switched to each other.

In operation 802, the communicator 110 may transmit the data indicating that the functions of the first terminal 210 and the second terminal 220 are switched to each other, to each of the first terminal 210 and the second terminal 220.

When the functions of the first terminal 210 and the second terminal 220 are switched, elements performing operations 805 through 885 of FIG. 8 may be changed as compared to corresponding operations 505 through 585 of FIG. 5.

As an example, in operation 805, the processor 120 of the server 100 may select a plurality of questions. For example, operation 805 may be performed identically to operation 505 corresponding to operation 805. In operation 810, the communicator 110 of the server 110 may transmit data indicating the selected questions to the second terminal 220 in lieu of the first terminal 210 to which the data is transmitted in operation 510.

In operation 815, the second user of the second terminal 220 may set a second question. The second terminal 220 may receive the question set by the second user.

The foregoing descriptions related to the first question may also be applicable to the second question.

In operation 820, the communicator 110 may receive, from the second terminal 220, the data indicating the second question set by the second user of the second terminal 220.

In operation 825, the processor 120 may generate a plurality of solutions of the second question.

The foregoing descriptions related to the plurality of solutions of the first question may also be applicable to the plurality of solutions of the second question.

In operation 830, the communicator 110 may transmit the data indicating the second question to the first terminal 210.

In operation 835, the first user of the first terminal 210 may generate a third solution of the second question. The first terminal 210 may receive the third solution of the second question from the first user.

The foregoing descriptions related to the first solution may also be applicable to the third solution.

In operation 840, the communicator 110 may receive, from the first terminal 210, data indicating the third solution selected by the first user from the plurality of the solutions of the second question.

In operation 845, the communicator 110 may transmit the data indicating the third solution to the second terminal 220.

In operation 850, the second terminal 220 may receive a second review of the third solution from the second user. The second terminal 220 may generate data indicating the received second review.

The foregoing descriptions related to the first review may also be applicable to the second review.

In operation 855, the communicator 110 may receive data indicating the second review of the second user with respect to the third solution, from the second terminal 220.

In operation 860, the communicator 110 may transmit the data indicating the second review to the first terminal 210.

In operation 862, the first terminal 210 may provide the data indicating the second review to the first user.

The first terminal 210 may provide, to the user, at least one of a result that the second user determines whether the third solution is an answer to the second question and a comment of the second user with respect to the third solution.

Through this, the first user may verify whether the third solution created or selected by the first user is the answer to the second question.

In operation 865, the first terminal 210 may receive a fourth solution selected by the first user. The first terminal 210 may generate data indicating the received fourth solution.

The fourth solution may be, for example, a solution selected by the first user from the plurality of solutions. The first user may select the fourth solution in consideration of the second review on the third solution.

In operation 870, the communicator 110 may receive, from the first terminal 210, the data indicating the fourth solution selected by the first user from the plurality of solutions.

The foregoing operations 845 through 870 may not be performed. For example, operation 875 may be performed after operation 840.

In operation 875, the processor 120 may determine whether the fourth solution is the answer to the second question.

Also, when operations 845 through 870 are not performed, the processor 120 may determine whether the third solution is the answer to the second question.

In operation 880, the communicator 110 may transmit data indicating whether the fourth solution is the answer to the second question, to the first terminal 210.

Also, when operations 845 through 870 are not performed, the processor 120 may generate the data indicating whether the third solution is the answer to the second question. The communicator 110 may transmit the data indicating whether the third solution is the answer to the second question, to the first terminal 210.

In operation 885, the processor 120 may provide a reward to the first user of the first terminal 210 when the fourth solution is the answer to the second question.

Also, when operations 845 through 870 are not performed, and when the third solution is the answer to the second question, the processor 120 may provide a reward to the first user of the first terminal 210.

Operations 610 through 630 described with reference to FIG. 6 may be performed after operation 870.

Operations 710 through 730 described with reference to FIG. 7 may be performed in a process of performing operations 830 through 885.

After operation 885 is performed, the processor 120 may switch the functions of the first terminal 210 and the second terminal 220 again. When the functions of the first terminal 210 and the second terminal 220 are switched again, operations 505 through 585 described with reference to FIG. 5 may be performed.

Since the descriptions provided with reference to FIGS. 1 through 7 are also applicable here, repeated descriptions will be omitted for increased clarity and conciseness.

FIG. 9 is a signal flowchart illustrating a room removal method according to an example embodiment.

Operation 340 in which the room is removed as described with reference to FIG. 4 may include operations 910 and 920.

In operation 910, the communicator 110 may receive data indicating a request for removing a room, from the first terminal 210 or the second terminal 220. The room requested to be removed may be a room generated in response to a request from the first terminal 210 in operation 310, among a plurality of rooms provided by the server 100.

In operation 920, the processor 120 may remove the room requested to be removed.

When the room is removed, the server 100 may allow the first terminal 210 and the second terminal 220 to exit the room.

To provide the learning service to a user of the first terminal 210 and a user of the second terminal 220, operation 310 described with reference to FIG. 3 may be performed again.

Since the descriptions provided with reference to FIGS. 1 through 8 are also applicable here, repeated descriptions will be omitted for increased clarity and conciseness.

FIG. 10 illustrates a method of selecting an English sentence corresponding to a suggested Korean sentence according to an example embodiment.

A first question may be a question about an English sentence corresponding to a Korean sentence 1020. The English sentence may be configured with portions 1040 through 1044 of the English sentence.

A plurality of solutions 1030 through 1034 may be provided to generate the English sentence corresponding to the Korean sentence 1020 in the first question or each of the portions 1040 through 1044 of the English sentence.

In an example, a second user may select the portion 1044 to complete the English sentence. The portion 1044 may be selected from the plurality of solutions 1030 through 1034. Among the plurality of solutions 1030 through 1034, a portion of the English sentence corresponding to a portion, “woorireul weehae”, of the Korean sentence 1020 may be the solution 1034, for example, “for us”.

In an example, among the plurality of solutions 1030 through 1034, a solution corresponding to an answer to the first question may be the solution 1034, “for us” configured with words indicating the English sentence corresponding to the Korean sentence 1020. Among the plurality of solutions 1030 through 1034, solutions not corresponding to the answer to the first question may be the solution 1030, “for all” and the solution 1032, “to me” including words not indicating the English sentence corresponding to the Korean sentence.

The second user of the second terminal 220 may complete the English sentence by selecting the solution 1034, “for us”.

When the second user selects the solution 1034, “for us”, the first solution may be “She will be praying for us”.

Since the descriptions provided with reference to FIGS. 1 through 9 are also applicable here, repeated descriptions will be omitted for increased clarity and conciseness.

FIG. 11 illustrates a method of reviewing a solution and requesting an explanation about a question according to an example embodiment.

When a first solution 1140 of a first question 1120 is provided to a first user of the first terminal 210, the first user may generate a first review 1130 based on the first question 1120 and the first solution 1140. The first review 1130 may indicate whether the first solution 1140 is an answer to the first question 1120. Alternatively, the first review 1130 may include a hint of the first question 1120.

In an example, when the first user determines that an English sentence corresponding to “Naneun mogie moollyeotta” in Korean is “I being bitten from mosquito”, the first user may select “o (think it's correct)” as a first review. When the first user determines that an English sentence corresponding to “Naneun mogie moollyeotta” in Korean is not “I being bitten from mosquito”, the first user may select “x (maybe incorrect)” as the first review. A determination of the first user may be transferred to a second user of the second terminal 220 through the server 100 as the first review.

The first user of the first terminal 210 may push an “explanation” button 1150 to transmit data indicating a request for an explanation about the first question 1120, to the server 100.

In operations 530 through 570, the “explanation” button 1150 may be provided to the first terminal 210. In operations 575 through 585, the “explanation” button 1150 may be provided to the first terminal 210 and the second terminal 220.

Since the descriptions provided with reference to FIGS. 1 through 10 are also applicable here, repeated descriptions will be omitted for increased clarity and conciseness.

FIG. 12 illustrates a method of reviewing a solution and indicating a requested history.

In FIG. 12, comments 1230 and 1232 may indicate a first review on first solution 1240 of a first question 1220.

A first user of the first terminal 210 may input or create the comment 1230 or the comment 1232 based on the first question 1220 and the first solution 1240. The first terminal 210 may receive the comment 1230 or the comment 1232 input or created by the first user. The first terminal 210 may transmit data indicating the comments 1230 through 1232 to the communicator 110 of the server 100, and the communicator 110 may transfer the data indicating the comments 1230 through 1232 to the second terminal 220.

Also, the comments 1230 and 1232 may be processed as a portion of a history 1210. For example, the history 1210 may include the first question 1220, the first solution 1240, and the comments 1230 and 1232 of the first review.

Since the descriptions provided with reference to FIGS. 1 through 11 are also applicable here, repeated descriptions will be omitted for increased clarity and conciseness.

FIG. 13 illustrates a method of providing a reward according to an example embodiment.

When the processor 120 of the server 100 determines whether a second solution is an answer to a first question, the communicator 110 of the server 110 may transmit a result 1310 indicating whether the second solution is the answer, to the second terminal 220.

When the second solution is the answer to the first question, the processor 120 of the server 100 may provide a reward to a second user of the second terminal 220.

The provided reward may be at least one of a point 1320 for increasing a game level of the second user and a point 1330 necessary for the second user to user a learning service.

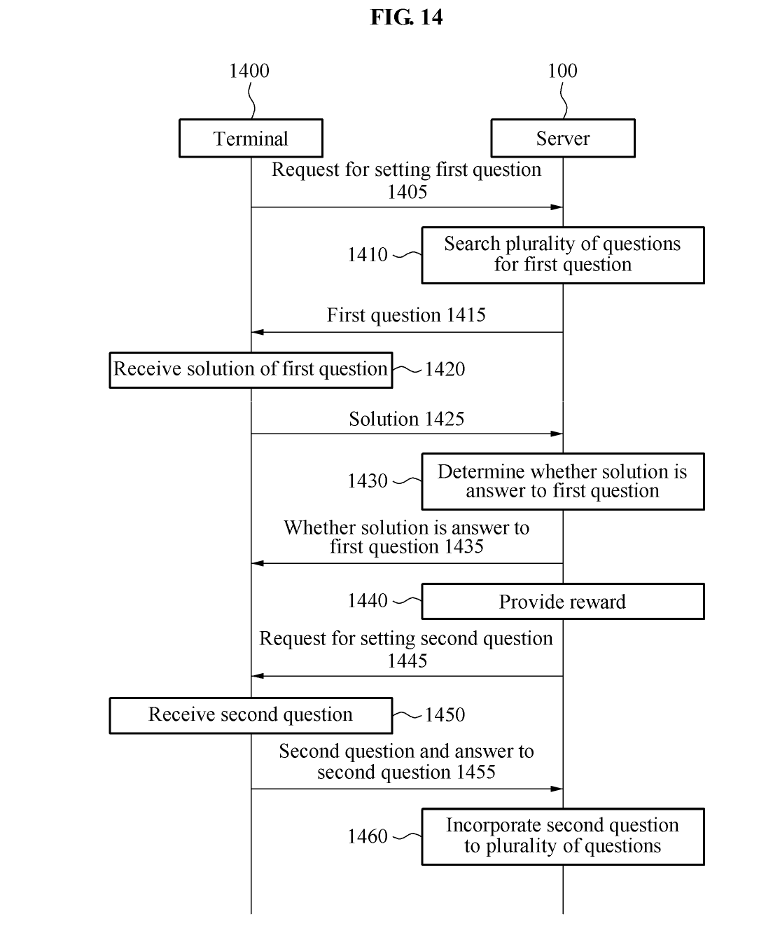

A learning service method may be provided based on a scheme in which the server 100 provides a question set by a differing user to a terminal as well as a one-to-one question solving scheme. Descriptions related to a method in which the server 100 provides the learning service method to a user of a terminal by sending a question set by a differing user will be provided with reference to FIG. 14.

Since the descriptions provided with reference to FIGS. 1 through 12 are also applicable here, repeated descriptions will be omitted for increased clarity and conciseness.

FIG. 14 is a signal flowchart illustrating a method of providing a question to a terminal according to an example embodiment.

In operation 1405, a terminal 1400 may transmit a request for setting a first question to the server 100.

When the terminal 1400 transmits the request for setting the first question to the server 100, the terminal 1400 may transmit information on a user of the terminal 1400 to the server 100. The information on a user may include, for example, a learning level of the user.

The communicator 110 may receive the request for setting the first question from the terminal 1400.

The terminal 1400 may correspond to the first terminal 210 or the second terminal 220. For example, descriptions related to the terminal 1400 may be replaced by the descriptions related to the first terminal 210 or the second terminal 220.

In operation 1410, the processor 120 may search the first question from a plurality of question based on a learning level of a user of the terminal 1400. A difficulty level corresponding to a learning level may be set for each of the plurality of questions.

The plurality of questions may be generated by a user of the server 100. For example, the plurality of questions may be generated by a plurality of users of the server 100. The storage 130 may store the generated questions.

In operation 1415, the communicator 110 may transmit data indicating the first question to the terminal 1400.

The terminal 1400 may receive the data indicating the first question from the server 100.

In operation 1420, the terminal 1400 may receive a solution of the first question. For example, the terminal 1400 may receive a solution selected by the user of the terminal 1400 from a plurality of solutions of the first question.

In operation 1425, the terminal 1400 may transmit data indicating the solution selected by the user of the terminal 1400 from the plurality of solutions of the first question, to the server 100.

The communicator 110 may receive the data indicating the solution selected by the user of the terminal 1400 from the plurality of solutions of the first question, from the terminal 1400.

In operation 1430, the processor 120 may determine whether the selected solution is an answer to the first question.

In operation 1435, the communicator 110 may transmit data indicating whether the selected solution is the answer to the first question, to the terminal 1400.

The terminal 1400 may receive the data indicating whether the selected solution is the answer to the first question, from the server 100.

In operation 1440, when the selected solution is the answer to the first question, the processor 120 may provide a reward to the user of the terminal 1400.

The descriptions related to operation 1440 may correspond to the foregoing descriptions related to operation 585.

In operation 1445, the communicator 110 may transmit a request for setting a second question for another user, to the terminal 1400.

In operation 1450, the terminal 1400 may receive the second question set by a user of the terminal 1400 from the user of the terminal 1400. Also, the terminal 1400 may receive an answer to the second question from the user of the terminal 1400.

A difficulty level of the second question may be set by the user of the terminal 1400.

Operation 1450 may also be performed when operation 1445 is not performed. For example, operation 1450 may be performed after operation 1435.

In operation 1455, the terminal 1400 may transmit the second question and the answer to the second question to the server 100.

The communicator 110 may receive the second question and the answer to the second question from the terminal 1400.

In operation 1460, the processor 120 may incorporate the received second question in the plurality of questions.

Since the descriptions provided with reference to FIGS. 1 through 13 are also applicable here, repeated descriptions will be omitted for increased clarity and conciseness.

The method according to example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

The embodiments may include computer-readable media including program instructions to implement various operations embodied by a computer. In particular, the embodiments may include computer-readable media with recorded programs including a content display code for displaying digital content on a screen of a touch sensing display, an object recognition code for recognizing an object selected by a user from digital content in response to a touch input of the user on the touch sensing display, an annotation storage code for generating and storing annotation data in which annotation is applied to an object in response to a user request, an annotation count code for counting the number of items of annotation data generated for each item in which description of the digital content is classified, and an annotation providing code for providing the number of items of annotation data for each item in response to a user request. A program according to the embodiments may include a PC based program a mobile terminal dedicated application, for example, a smart phone application, a picture phone virtual machine, and the like. The program may be stored in a memory of a user terminal and/or an e-book service system and thereby be executed by at least one processor that is driven in the user terminal and/or the e-book service system.

1. A learning service method performed by a server, the method comprising:
receiving, from a first terminal, data indicating a first question set by a first user of the first terminal;
transmitting the data indicating the first question to a second terminal;
receiving data indicating a first solution selected by a second user of the second terminal from a plurality of solutions of the first question, from the second terminal;
transmitting the data indicating the first solution to the first terminal;
receiving data indicating a first review of the first user with respect to the first solution from the first terminal;
transmitting the data indicating the first review to the second terminal;
receiving data indicating a second solution selected by the second user from the plurality of solutions, from the second terminal;
determining whether the second solution is an answer to the first question; and
transmitting data indicating whether the second solution is the answer to the first question to the second terminal.

2. The method of claim 1, wherein the first question is a question about an English sentence corresponding to a suggested Korean sentence, and
wherein, among the plurality of solutions, a solution corresponding to the answer to the first question includes words indicating the English sentence and a solution differing from the answer to the first question includes words not indicating the English sentence.

3. The method of claim 1, wherein the first question is a question about an English sentence corresponding to a suggested Korean sentence, and
wherein the plurality of solutions are solutions corresponding to a portion of the English sentence.

4. The method of claim 1, wherein the data indicating the first review is at least one of data indicating a selection of the first user performed on whether the first solution is the answer to the first question and data indicating a comment from the first user with respect to the first solution.

5. The method of claim 1, further comprising:
providing a reward to the second user of the second terminal when the second solution is the answer to the first question.

6. The method of claim 1, further comprising:
receiving, from the first terminal or the second terminal, data indicating a request for a history in which one of the first question, the first solution, the first review, and the second solution is recorded;
generating the history; and
transmitting the data indicating the generated history to the first terminal or the second terminal from which the request for the history is received.

7. The method of claim 1, further comprising:
receiving data indicating a request from the first terminal to create a room;
creating a first room;
allowing the first terminal to enter the first room;
receiving data indicating a request for entering the first room from the second terminal; and
allowing the second terminal to enter the first room,
wherein the first room is added to at least one room provided by the server and, in each of the at least one room, a question is set and solved by a user of at least one terminal entering a corresponding room.

8. The method of claim 7, further comprising:
inviting the second user as a solver of the first question,
wherein the data indicating the request for creating the room comprises data indicating the second terminal of which entry to the first room to be created is allowed by the first user of the first terminal, and
wherein the inviting comprises transmitting data indicating an invitation to the created first room, to the second terminal to which entry is allowed.

9. The method of claim 7, further comprising:
receiving data indicating a request for removing the first room, from the first terminal or the second terminal; and
removing the first room.

10. The method of claim 7, further comprising:
transmitting data on a recommended user list as a candidate user to be allowed entry to the first room, to the first terminal,
wherein the recommended user list comprises the second user of the second terminal.

11. The method of claim 10, wherein the recommended user list is a list representing at least one user having a level within a range determined based on a level of the first user of the first terminal.

12. The method of claim 1, further comprising:
generating data indicating an explanation about the first question; and
transmitting data indicating the explanation of the first question to at least one of the first terminal and the second terminal.

13. The method of claim 1, further comprising:
transmitting data indicating that functions of the first terminal and the second terminal are switched to each other, to the first terminal and the second terminal;
receiving data on a second question set by the second user from the second terminal;
transmitting the data on the second question to the first terminal;
receiving data indicating a third solution selected by the first user from a plurality of solutions of the second question, from the first terminal;
transmitting the data indicating the third solution to the second terminal;
receiving data indicating a second review of the second user with respect to the third solution from the second terminal;
transmitting the data indicating the second review to the first terminal;
receiving data indicating a fourth solution selected by the first user from the plurality of solutions, from the first terminal;
determining whether the fourth solution is an answer to the second question; and
transmitting data indicating whether the fourth solution is the answer of the second question, to the first terminal.

14. The method of claim 1, further comprising:
selecting a plurality of questions based on at least one of a level of the first user and a level of the second user from questions provided in the server; and
transmitting data indicating the plurality of questions to the first terminal,
wherein the first question is one of the plurality of questions.

15. A non-transitory computer-readable storage medium storing instructions to cause a computer to perform the method of claim 1.

16. A learning service server comprising:
a communicator; and
a processor,
wherein the communicator is configured to receive data indicating a first question set by a first user of a first terminal from the first terminal, transmit the data indicating the first question to a second terminal, receive data indicating a first solution selected by a second user of the second terminal from a plurality of solutions of the first question from the second terminal, transmit the data indicating the first solution, receive data indicating a first review of the first user with respect to the first solution from the first terminal, transmit the data indicating the first review to the second terminal, receive data indicating a second solution selected by the second user from the plurality of solutions from the second terminal, and transmit data indicating whether the second solution is an answer to the first question to the second terminal, and
wherein the processor is configured to determine whether the second solution is the answer to the first question.

17-26. (canceled)

27. A learning service method performed by a server, the method comprising:
searching a plurality of questions for a first question based on a learning level of a user of a terminal;
transmitting data indicating the first question to the terminal;
receiving data indicating a solution selected by the user of the terminal from a plurality of solutions of the first question from the terminal;
determining whether the solution is an answer to the first question; and
transmitting data indicating whether the solution is the answer to the first question to the terminal.

28. The method of claim 27, further comprising:
receiving a second question generated by the user of the terminal and an answer to the second question from the terminal; and
incorporating the second question to the plurality of questions.

29. The method of claim 28, wherein a difficulty level of the second question is set by the user.

30. The method of claim 27, further comprising:
transmitting a request for setting a second question for another user to the terminal.

31-34. (canceled)
